(19) United States
(12) Patent Application Publication
(10) Pub. No.: US 2019/0391846 A1
(43) Pub. Date: Dec. 26, 2019

(54) SEMICONDUCTOR INTEGRATED CIRCUIT, CPU ALLOCATION METHOD, AND PROGRAM

(71) Applicant: RENESAS ELECTRONICS CORPORATION, Tokyo (JP)

(72) Inventors: Keita KOBAYASHI, Tokyo (JP); Takahiko GOMI, Tokyo (JP); Ryu NAGASAWA, Tokyo (JP)

(21) Appl. No.: 16/411,942

(22) Filed: May 14, 2019

(30) Foreign Application Priority Data
Jun. 20, 2018 (JP) 2018-117087

(51) Int. Cl. G06F 9/48; G06F 9/50

(52) U.S. Cl. CPC G06F 9/4881; G06F 9/505; G06F 9/5094

(57) ABSTRACT

The semiconductor integrated circuit includes a plurality of CPUs (big CPU and LITTLE CPU). Each of CPUs has a different performance respectively. The semiconductor integrated circuit determines an effective CPU allocated to a task realized by at least one of the plurality of functional blocks according to the device table defining a relationship between the plurality of functional blocks and any one of the plurality of CPUs.

### CROSS-REFERENCE TO RELATED APPLICATIONS

The disclosure of Japanese Patent Application No. 2018-117087 filed on Jun. 20, 2018 including the specification, drawings and abstract is incorporated herein by reference in its entirety.

### BACKGROUND

The present invention relates to a semiconductor integrated circuit, a central processing unit (CPU) allocation method, and a program, and relates to, for example a semiconductor integrated circuit including a plurality of CPUs.

In order to cause a processor to execute high performance processing with low-power consumption, a multiprocessor system in which a plurality of processors is operated in parallel has been proposed. Multiprocessor systems include symmetric multiple processor (SMP) systems and asymmetric multiple processor (ASMP) systems. The SMP is composed of a plurality of processors having the same performance. On the other hand, the ASMP is composed of combinations of a plurality of processors having different performances.

For example, Japanese unexamined Patent Application No. 2006-338184 discloses an example of an SMP. “ARM Limited, Big. LITTLE Technology: The Future of Mobile, [online], Internet <URL: https://www.arm.com/files/pdf/big_LITTLE_Technology_the_Futue_of_Mobile.pdf>, the retrieval date: Feb. 23, 2018” and International Publication No. 2014/188561 disclose examples of an ASMP. “ARM Limited, Big. LITTLE Technology: The Future of Mobile, [online], Internet <URL: https://www.arm.com/files/pdf/big_LITTLE_Technology_the_Futue_of_Mobile.pdf>, the retrieval date: Feb. 23, 2018” proposes a technique (big.LITTLE) in which a CPU core (big) having high performance and a CPU core (LITTLE) consuming low power are combined. The big.LITTLE is a technique for realizing both high performance and low-power consumptions in battery-driven terminal devices such as mobiles. The big.LITTLE dynamically allocates a CPU to process a task between a big and a LITTLE according to the CPU loading of the task. As a result, an optimum CPU is allocated to each task to be processed.

International Publication No. 2014/188561 discloses a multi-CPU system having definition information defining a plurality of forms of combinations of types and numbers of CPUs. In the definition information, a plurality of forms is defined such that the maximum value of the overall data processing performance and the power consumption differs in multiple stages. The multi-CPU system allocates the data processing to the CPU specified in the form selected from the definition information in accordance with the environment of the data processing.

### SUMMARY

For example, a big. LITTLE configuration as disclosed in “ARM Limited, Big. LITTLE Technology: The Future of Mobile, [online], Internet <URL: https://www.arm.com/files/pdf/big_LITTLE_Technology_the_Futue_of_Mobile.pdf>, the retrieval date: Feb. 23, 2018” may be required to meet both performance and power consumption requirements. In a typical big. LITTLE, either big CPU or LITTLE CPU is allocated based only on the CPUs loads. Despite the high load of the entire system, including the CPU and associated functional blocks, tasks with low CPU load are allocated low-performance CPUs. If the CPU that operates the task is determined based only on the CPU load, the required processing performance cannot be achieved.

Other objects and new features will be apparent from the descriptions of the present specification and the accompanying drawings.

A semiconductor integrated circuit according to an embodiment includes a plurality of CPUs. Each of CPUs has a different performance respectively. The semiconductor integrated circuit determines an effective CPU allocated to a task realized by at least one of the plurality of functional blocks according to definition information defining a relationship between the plurality of functional blocks and any one of the plurality of CPUs.

A CPU allocation method according to an embodiment is a method of allocating a CPU in a semiconductor integrated circuit including a plurality of CPUs and a plurality of functional blocks. Each of CPUs has a different performance respectively. The method comprises determining an effective CPU allocated to a task realized by at least one of the plurality of functional blocks according to definition information defining a relationship between the plurality of functional blocks and any one of the plurality of CPUs.

A program according to an embodiment is a program executed by a semiconductor integrated circuit including a plurality of CPUs and a plurality of functional blocks. Each of CPUs has a different performance respectively. The program causes at least one of the plurality of CPUs to execute a step of determining an effective CPU allocated to a task realized by at least one of the plurality of functional blocks according to definition information defining a relationship between the plurality of functional blocks and any one of the plurality of CPUs.

According to one embodiment, it is possible to maintain or improve the performance of a system composed of a plurality of CPUs having different performances.

### BRIEF DESCRIPTION OF THE DRAWINGS

FIG. 1 is a block diagram showing a configuration example of a semiconductor integrated circuit according to a first embodiment.

FIG. 2 is a diagram illustrating a configuration of hardware and software of the semiconductor integrated circuit illustrated in FIG. 1 in a hierarchical manner.

FIG. 3 is a diagram showing a data structure of definition information according to the first embodiment.

FIG. 4 is a schematic diagram illustrating an outline of a CPU allocation determination unit (governor) according to the first embodiment.

FIG. 5 is a diagram schematically illustrating scheduling based only on a CPU processing time in an asymmetric multiple processor system.

FIG. 6 is a schematic diagram illustrating an example of a performance degradation caused by an allocation of tasks to a LITTLE CPU in an asymmetric multiple processor system.

FIG. 7 is a flowchart illustrating an operation flow of the CPU allocation determination unit (governor) according to the first embodiment.

FIG. 8 is a schematic diagram illustrating a configuration of the hardware and software of a semiconductor integrated circuit according to a second embodiment in a hierarchical manner.

FIG. 9 is a data structure of definition information according to the second embodiment.

FIG. 10 is a schematic diagram illustrating an outline of a CPU allocation determination unit (governor) according to the second embodiment.

FIG. 11 is a flowchart illustrating an operation flow of the CPU allocation determination unit (governor) according to the second embodiment.

FIG. 12 is a diagram illustrating a configuration of hardware and software of a semiconductor integrated circuit according to a third embodiment in a hierarchical manner.

FIG. 13 is a diagram illustrating a data structure of definition information according to the third embodiment.

FIG. 14 is a flowchart illustrating an operation flow of a CPU allocation determination unit (governor) according to the third embodiment.

### DETAILED DESCRIPTION

Hereinafter, each embodiment will be described in detail with reference to the accompanying drawings. The same or corresponding portions are denoted by the same reference numerals, and description thereof will not be repeated.

### First Embodiment

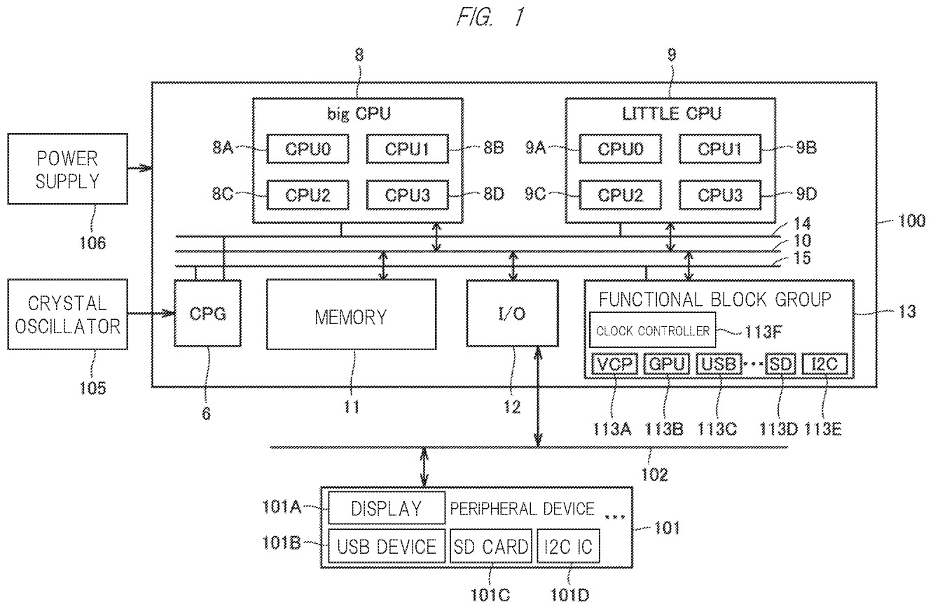

FIG. 1 is a block diagram showing a configuration example of a semiconductor integrated circuit according to a first embodiment. As shown in FIG. 1, the semiconductor integrated circuit 100 is configured as an asymmetric multiple processor in which a plurality of CPUs having different data processing performances are mounted. The semiconductor integrated circuit 100 may be configured by a single chip or may be configured by a multi-chip. In one embodiment, the semiconductor integrated circuit 100 constitutes an in-vehicle information system. This system can be implemented in the semiconductor integrated circuit 100 in the form of a System on-a Chip (SoC).

The semiconductor integrated circuit 100 is connected to a peripheral device 101 via a bus 102. The peripheral device 101 may include, for example, a display 101A, a universal serial bus (USB) device 101B, an SD card 101C, a communication device, such as an I2C IC 101D, and the like.

The semiconductor integrated circuit 100 includes a first CPU group (big CPU) 8 having high data processing performance and high-power consumption, and a second CPU group (LITTLE CPU) 9 having low data processing performance and low-power consumption. The first CPU group 8 includes CPUs 8A, 8B, 8C, and 8D denoted by “CPU0”, “CPU1”, “CPU2”, and “CPU3”, respectively. Each of CPUs 8A, 8B, 8C, and 8D is a high-performance CPU. The second CPU group 9 includes CPUs 9A, 9B, 9C, and 9D denoted by “CPU0”, “CPU1”, “CPU2”, and “CPU3”, respectively. Each of CPUs 9A, 9B, 9C, and 9D is a low-performance CPU. The number of CPUs included in each CPU group is not particularly limited.

The CPUs 8A to 8D of the first CPU group 8 and the CPUs 9A to 9D of the second CPU group 9 are connected to a memory 11, an input/output (I/O) circuit 12, and a functional block group 13 via a bus 10. Further, the CPUs 8A to 8D of the first CPU group 8 and the CPUs 9A to 9D of the second CPU group 9 are connected to a clock pulse generator 6 via an internal clock bus 14.

The input/output interface circuit 12 is connected to the peripheral device 101 via the bus 102. The functional block group 13 includes a plurality of functional blocks for realizing various functions. In this specification, a “functional block” is constituted by a circuit, i.e., hardware. Hereinafter, the name “device” refers to a functional block. The functional block group 13 may include, but is not limited to, a video coding processor (VCP) 113A, a graphic processing unit (GPU) 113B, a USB controller 113C, an SD host controller 113D, an I2C controller 113E, a clock controller 113F, and the like. Each functional block of the functional block group 13 is connected to the clock pulse generator 6 via a peripheral clock bus 15.

The clock pulse generator 6 receives a source clock from a crystal oscillator 105 and generates an internal clock and a peripheral clock. The clock pulse generator 6 supplies the internal clock to the first CPU group 8 and the second CPU group 9 via an internal clock bus 14. Further, the clock pulse generator 6 supplies the peripheral clock to each functional block of the functional block group 13 via the peripheral clock bus 15.

A power supply 106 supplies a power supply voltage to the semiconductor integrated circuit 100. When a task transitions to a RUNNING state, the functional blocks for realizing the task are powered on. Further, the peripheral clock is supplied to the functional blocks. As a result, the functional blocks are put into an operating state. The clock controller 113F manages supply of a clock to each functional block. Therefore, the clock controller 113F can grasp an on state and an off state of each functional block.

The first CPU group 8 and the second CPU group 9 execute programs. A “program” is an operating system (OS) or an application program. Each CPU executes the operating system and the application program.

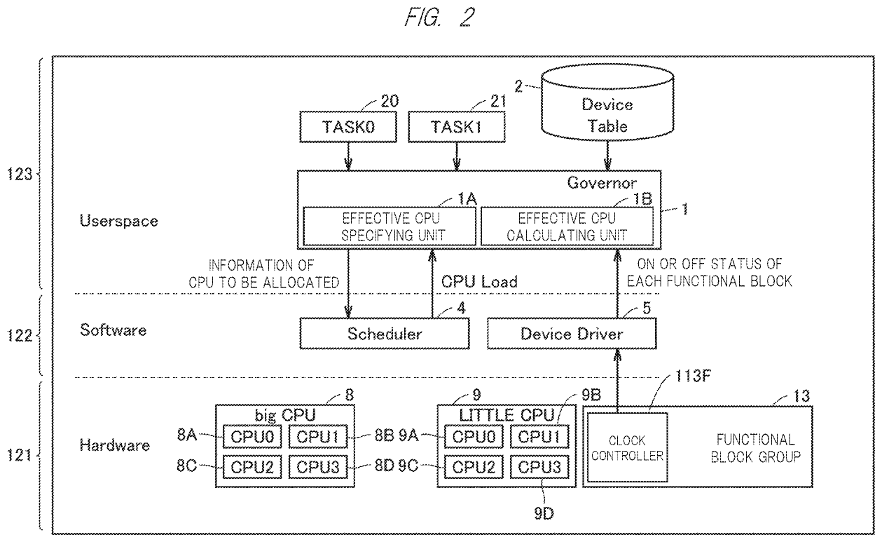

FIG. 2 is a diagram illustrating a configuration of hardware and software of the semiconductor integrated circuit 100 illustrated in FIG. 1 in a hierarchical manner. As shown in FIG. 2, the hardware and software configuration of the semiconductor integrated circuit 100 can be represented by three layers, i.e., a hardware layer (Hardware) 121, a software layer (Software) 122 and a user space layer (User space) 123.

As described above, the hardware layer 121 includes the first CPU group 8, the second CPU group 9, and the functional block group 13. The functional block group 13 includes the clock controller 113F that manages a clock supply state (clock ON/OFF) to each functional block.

The software layer 122 is an operating system running on the CPU. One example of the operating system is Linux (registered trademark). The software layer 122 implements functions of a scheduler 4 and a device driver 5. The scheduler 4 is a function used for task management, and performs scheduling or dispatching for allocating tasks to CPUs. The device driver 5 controls each functional block included in the functional block group 13. Further, the device driver 5 receives information on the supply of the clock to each functional block from the clock controller 113F, and detects whether the functional block is in the on state or the off state. The device driver exists for each functional block. For simplicity of illustration, a plurality of device drivers is collectively referred to as the device driver 5 in FIG. 2 and the figures described below.

The user space layer 123 is an application program that runs on the CPU. A governor 1 determines to which of big CPU (CPUs 8A to 8D) and Little CPU (CPUs 9A to 9D) the tasks are to be allocated. That is, the governor 1 functions as a CPU allocation determination unit.

A device table 2 holds definition information defining correspondence relationships between a plurality of functional blocks (devices) and a plurality of CPUs. That is, the device table 2 has information on the effective CPU allocated to the operation of the task (effective CPU information). The CPU allocated to each of the plurality of functional blocks is defined in advance according to a processing time of the functional block.

The definition information included in the device table 2 is defined in advance by, for example, performing profiling of the system. The device table 2 is stored in, for example, a nonvolatile memory. The device table 2 is called from the nonvolatile memory by the CPU when the program is executed, and is temporarily stored in a volatile memory inside the CPU.

The governor 1 includes an effective CPU specifying unit 1A and an effective CPU calculating unit 1B. The effective CPU specifying unit 1A receives information on the status (on or off) of each functional block from the device driver 5, and refers to the device table 2 to determine a CPU group to which a task in an execution state is to be allocated from the first CPU group 8 and the second CPU group 9. Alternatively, the effective CPU specifying unit 1A determines the CPU group to which the task in the execution state is to be allocated from the first CPU group 8 and the second CPU group 9 based on the processing time of the CPU calculated by the effective CPU calculating unit 1B. The effective CPU specifying unit 1A inputs the determined CPU group to the scheduler 4. As a result, the task in the execution state is operated by the CPU of the specified CPU group. FIG. 2 shows tasks 20 and 21 respectively represented by “TASK0” and “TASK1” as tasks in the execution state. One task controls one functional block.

FIG. 2 shows that a plurality of tasks is in a substantially simultaneous execution state. Since processing of allocating CPUs is executed for each task, a plurality of processes for allocating CPUs to a plurality of tasks is executed in parallel.

The effective CPU calculating unit 1B calculates the processing time or usage rate of each CPU of the first CPU group 8 and the second CPU group 9. For example, the effective CPU calculating unit 1B acquires information on the CPU load from the scheduler 4 and calculates the processing time or the usage rate of the CPU. The scheduler 4 generates information about the loading of the big CPU or Little CPU and sends the information to the governor 1. The information on the load of the CPU is the processing time of the CPU or the usage rate of the CPU described above.

The governor 1 and the scheduler 4 may be executed in either the first CPU group 8 (big CPU) or the second CPU group 9 (Little CPU). Depending on the loading conditions of these CPUs, it may be decided whether to execute the governor 1 or the scheduler 4 in the big CPU or the Little CPU. The device driver 5 may be executed by the same CPU as the CPU allocated to the task.

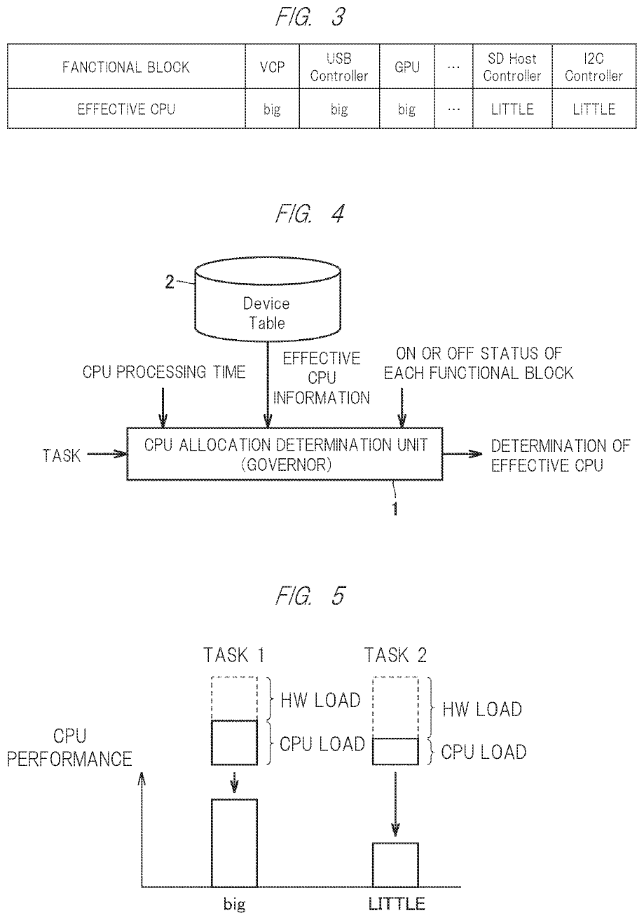

FIG. 3 is a diagram showing a data structure of the definition information according to the first embodiment. As shown in FIG. 3, in the definition information, the correspondence relationships between a plurality of functional blocks (VCP, USB controller, GPU, SD host controller, I2C controller, etc.) and a plurality of CPUs (big CPU or LITTLE CPU) are defined. In an example of FIG. 3, the functional blocks of the VCP, the USB controller, and the GPU are associated with the big CPU. These functional blocks are those that require high-performance CPUs (high processing performances). On the other hand, the SD host controller and the I 2 C controller are associated with the LITTLE CPU. These functional blocks are blocks that do not necessarily require high-performance CPUs (the performance of the entire system is less affected by the operation of tasks in the LITTLE CPU).

FIG. 4 is a schematic diagram for explaining an outline of the CPU allocation determination unit (governor 1) according to the first embodiment. Referring to FIG. 4, the CPU allocation determination unit (governor 1) acquires information on the status (on or off) of each functional block for each task in the execution state.

The governor 1 further refers to the device table 2. When the functional block in the operation state is a functional block registered in the device table 2, the effective CPU information is obtained from the device table 2. Based on the effective CPU information, the governor 1 determines a CPU (effective CPU) to be allocated to a task in the execution state. As shown in FIG. 2, when a plurality of tasks is simultaneously transitioning to the execution state, the governor 1 determines for each task whether the effective CPU allocated to the task is the big CPU or the LITTLE CPU. When a plurality of tasks is simultaneously transitioning to the execution state, a plurality of functional blocks to be controlled by the plurality of tasks is simultaneously in the operation state. In the first embodiment, the governor 1 checks whether or not each functional block is in the operation state, but does not check the relationship between the functional block and the task in the operation state. If a functional block associated with the big CPU is included in the functional blocks in operation state, the governor 1 allocates a big CPU to the task. On the other hand, when there is no functional block associated with the big CPU among the functional blocks in operation state, the governor 1 allocates a LITTLE CPU to the tasks.

When a plurality of tasks is in the execution state but all of the functional blocks registered in the device table 2 is in the non-operation state (i.e., when a functional block not registered in the device table 2 is in operation), the CPU allocation determination unit (governor 1) determines the effective CPU based on the CPU load. For example, the governor 1 determines the effective CPU based on the CPU processing time. When the CPU processing time is long (the CPU load is large), a big CPU is allocated, and when the CPU processing time is short (the CPU load is small), a LITTLE CPU is allocated. Instead of the CPU processing time, the CPU usage rate can be used to determine the effective CPU.

In the case of a symmetric multiple processor (SMP) system, since the system is composed of a plurality of CPUs of the same type, the processing performance of the CPUs is basically the same. Therefore, in the SMP, even if the effective CPU is determined based only on the CPU processing time, the problem of the performance degradation does not remarkably appear. On the other hand, in the present embodiment, an asymmetric multiple processor system (ASMP) is applied. In the ASMP, when the effective CPU is determined based only on the CPU load (e.g., CPU processing time), there is a possibility that the control is executed so that the performance is degraded even when the performance of the system is to be maintained or improved depending on the operating use case.

FIG. 5 is a diagram schematically showing scheduling based only on CPU processing time in an asymmetric multiple processor system. As shown in FIG. 5, for example, two tasks (“Task 1” and “Task 2”) are assumed. The “CPU load” represents the weight of a task to be processed by the CPU. Task 1 has a larger CPU load than Task 2.

It is assumed that scheduling is executed so that CPUs are allocated based only on the CPU load. In this instance, task 1 is allocated a big CPU and task 2 is allocated a LITTLE CPU. However, the use case does not consist only of the CPU, but rather of the entire system including the CPU and the functional blocks associated with the CPU. Therefore, the load of the entire system consists of the load of the CPU and the load of the hardware (HW). In order to realize the performance (throughput/low latency) required by the application, it is necessary to select an effective CPU in consideration of not only the CPU processing time but also the load of the functional block (for example, the processing time of the functional block). For example, executing Tasks 2 in the LITTLE CPU may degrade the performance of the systems.

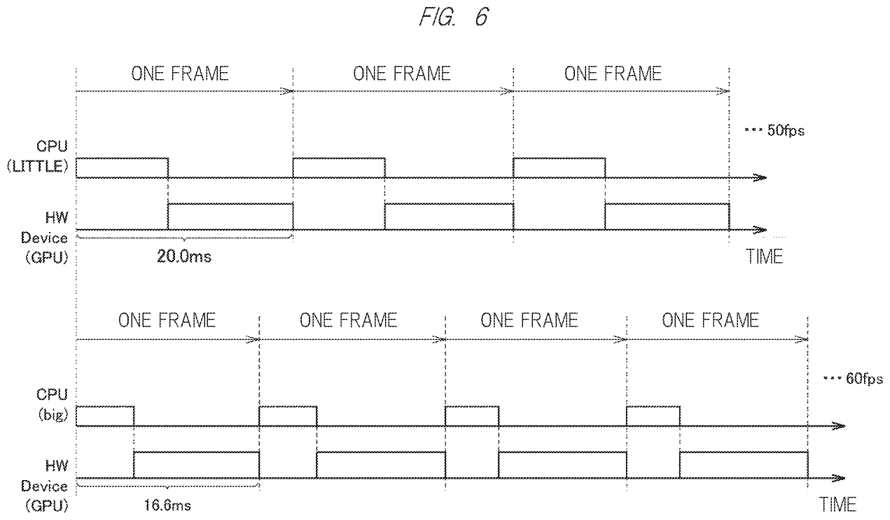

FIG. 6 is a schematic diagram showing examples of performance degradation caused by allocation of tasks to the LITTLE CPU in an asymmetric multiple processor system. In FIG. 6, drawing processing by CPUs (big or LITTLE) and a GPU (HW Device) are shown as examples. Note that the numerical values described below are examples used for explanation, and are not intended to limit the present embodiment.

Since the processing time is shortened by operating the tasks by the big CPU, the processing time of the GPU can be secured. In this case, since the total processing time is shortened, a higher frame rate can be realized. On the other hand, by operating tasks by the LITTLE CPU, the processing time is lengthened. In this case, it is conceivable that the processing does not end within a certain period of time. Therefore, the entire processing time becomes longer. That is, the frame rate decreases. In the combination of the big CPU and the GPU, the frame rate is, for example, 60 fps (drawing time of one frame is 16.6 ms). On the other hand, in the combination of the LITTLE CPU and the GPU, the frame rate is, for example, 50 fps (drawing time of one frame is 20.0 ms).

In this embodiment, the effective CPU is determined based on the definition information stored in the device table 2. The definition information is information on the correspondence relationship between the functional block and the effective CPU. This correspondence relationship is set in consideration of not only the CPU processing time of the task but also the processing time of the functional block. The effective CPU allocated to the task is determined according to the definition information. Thus, in a system composed of a plurality of CPUs having different performances, it is possible to prevent deterioration of the performance of the system.

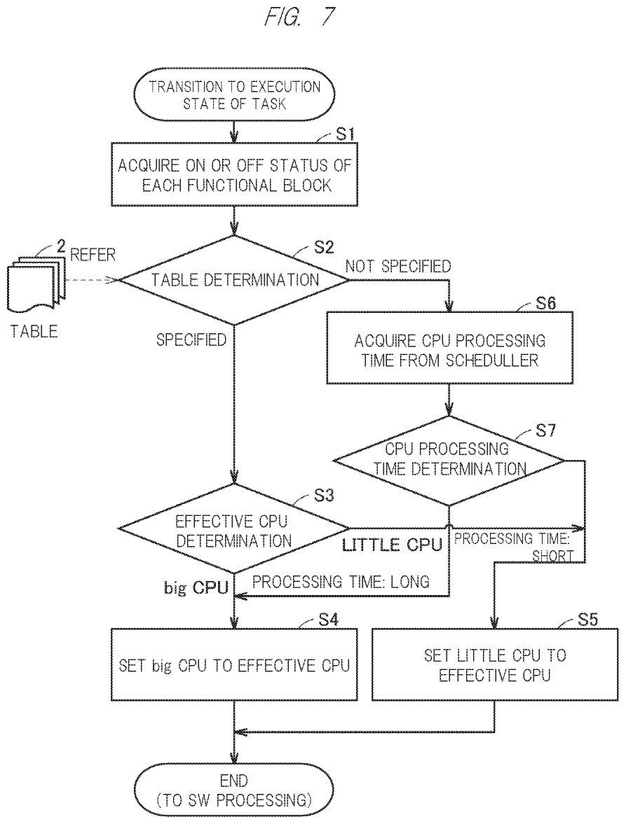

FIG. 7 is a flowchart illustrating an operation flow of the CPU allocation determination unit (governor 1) according to the first embodiment. Processing shown in the flow chart is executed by the big CPU or the LITTLE CPU. The flowchart of FIG. 7 shows an allocation processing of the CPU to one task. Hereinafter, a case where a plurality of tasks is simultaneously in the execution state will be described. In this case, the processing of the flowchart shown in FIG. 7 is executed in parallel by the number of tasks.

Referring to FIG. 7, a task transitions from an executable state to an execution state. In step S1, the governor 1 acquires information on the on state or off state of each functional block. More specifically, the clock controller 113F transmits information on the supply state of the clock to each functional block to the device driver 5. Based on the information, the device driver 5 generates information indicating that each functional block is either the on state or the off state. The device driver 5 transmits the information to the governor 1. That is, the governor 1 acquires the state of supply of power to each of the plurality of functional blocks, and determines the operation state of each functional block. More specifically, the governor 1 determines that the functional block to which the clock is supplied is the functional block in the operation state. By managing the clock of the functional block, it is possible to easily determine whether or not the functional block is in the operation state. Therefore, it can be easily determined whether or not the power is supplied to the functional block. In the first embodiment, it is possible to easily determine whether or not the functional block is in the operation state by a relatively simple method.

In step S2, the governor 1 executes table determination processing. The governor 1 determines whether or not each of the plurality of functional blocks in the operation state is a functional block specified in the device table 2. When at least one functional block specified in the device table 2 is included in the plurality of functional blocks in the operation state (step S2: “specified”), the governor 1 executes effective CPU determination processing in step S3.

In the determination processing of step S3, when at least one functional block associated with the big CPU is included in the device table 2 among the plurality of functional blocks in the operation state, the governor 1 determines that the effective CPU allocated to the task is the big CPU. In step S4, the governor 1 sets the big CPU to the effective CPU. The governor 1 inputs the effective CPU (big CPU) to the scheduler 4. On the other hand, if a functional block registered in the device table 2 is included in the plurality of functional blocks in the operation state, but the big CPU is not associated with the registered functional block (in other words, the LITTLE CPU is associated with the registered functional block), the governor 1 determines that the effective CPU allocated to the task is the LITTLE CPU. In step S5, the governor 1 sets the LITTLE CPU to the effective CPU. Similarly to step S4, the governor 1 inputs the effective CPU (LITTLE CPU) to the scheduler 4. When the effective CPU is input to the scheduler 4 in steps S4 or S5, the allocation processing of the effective CPU ends. Thereafter, software processing for the operation of the task is executed.

When a plurality of tasks is transitioning to the execution state, the timings for determining the effective CPUs of the tasks are substantially the same. When at least one functional block associated with the big CPU is included in the plurality of functional blocks in the operation state, the effective CPUs are set so that all tasks are executed by the big CPU. Referring to FIG. 3, for example, when the VCP 113A, the GPU 113B, and the SD host controller 113D are in the operation state, all tasks realized by these functional blocks are operated by the big CPU. Therefore, the performance of the system is prevented from deteriorating. On the other hand, in the step S3, when the plurality of functional blocks in the operation state is all associated with the LITTLE CPU, the effective CPUs are set so that all the tasks in the execution state are operated by the LITTLE CPU. Referring to FIG. 3, for example, the SD host controller 113D and the I2C controller 113E are in the operation state. All functional blocks associated with the big CPU are in non-operation state. In this instance, all tasks realized by the plurality of functional blocks in the operation state are operated by the LITTLE CPU. By executing a processing that does not require high performance by the LITTLE CPU, the power consumed by the system can be reduced.

When none of the plurality of functional blocks in the operation state is specified in the device table 2 (step S2: “not specified”), the governor 1 determines the effective CPU allocated to the task realized by the functional block in accordance with information on the CPU load for operating the task. “Not specified” in step S2 corresponds to a case where all the functional blocks registered in the device table 2 are in the non-operation state. In detail, the governor 1 acquires a CPU processing time based on the scheduling by the scheduler 4 (step S6). Next, the CPU processing time is determined (step S7). The processing of steps S6 and S7 are executed by the effective CPU calculating unit 1B.

In step S7, the effective CPU calculating unit 1B determines whether or not the CPU processing time is longer than a preset reference time. If it is determined that the CPU processing time is longer than the reference time, the processing proceeds to step S4. Therefore, the big CPU is set to the effective CPU. On the other hand, when it is determined that the CPU processing time is shorter than the reference time, the processing proceeds to step S5, and the LITTLE CPU is set to the effective CPU. Since the effective CPU is set according to the load of the CPU, when high processing performance is required, the performance required by operating the task by the high-performance CPU can be satisfied. On the other hand, when high processing performance is not necessarily required, power consumption can be reduced by operating the task by the low-performance CPU.

In the processing of step S7, the CPU usage rate may be used instead of the CPU processing time. In this case, the CPU usage rate is compared to a reference usage rate. If the CPU usage rate exceeds the reference usage rate, the big CPU is set to the effective CPU in step S4. If the CPU usage rate is less than the reference usage rate, the LITTLE CPU is set to the effective CPU in step S5.

The processing proceeds from step S7 to step S4 or step S5, and when the effective CPU is input to the scheduler 4, the allocation processing of the effective CPU ends. Thereafter, software processing for the operation of the task is executed.

If the functional block associated with the task is unknown (e.g., if an entirely new task transitions to the execution state), governor 1 has no information about the effective CPU. In this instance, the governor 1 sets the big CPU to the effective CPU. As a result, the performance of the system can be maintained. When the functional block is unknown, the governor 1 may set the effective CPU according to the operation state after the functional block is known.

In the first embodiment, the functional blocks and the effective CPUs are associated with each other by the device table 2. The governor 1 determines the effective CPU by referring to the device table 2. When a high processing performance is required for the system, i.e., a combination of a functional block and an effective CPU, the functional block and the high-performance CPU are associated with each other in the device table 2. Even if the task is a task with low CPU load, a high-performance CPU can be allocated to the task according to the device table 2. In particular, when at least one functional block associated with the big CPU is included in the plurality of functional blocks in the operation state, the effective CPUs are set so that all the tasks in operation are executed collectively by the big CPU. As a result, the processing performance of the system can be maintained or improved. On the other hand, when all the plurality of functional blocks in the operation state are associated with the LITTLE CPU, the effective CPUs are set so that all the tasks in the execution state are operated in the LITTLE CPU. When a high performance is not necessarily required, the power consumption of the system can be reduced by the task being operated by the low-performance CPU.

For example, in recent in-vehicle information system, there is a strong demand for performance, such as improving an operation response while simultaneously operating a plurality of applications. For this reason, for example, in an in-vehicle information system, a multiple processor is required to process a plurality of processing in parallel. On the other hand, it is often technically difficult to mount a plurality of high-performance CPUs in a system for reasons such as limitation of a size of hardware (die). Therefore, in the in-vehicle information system, not only a high-performance CPU but also a low-performance CPU which is advantageous in terms of a chip area are required. In the first embodiment, tasks can be allocated to appropriate CPUs based on the definition information or the CPU processing time. Therefore, in a system composed of a plurality of CPUs having different performances, it is possible to improve the performance of parallel processing while preventing performance degradation.

According to the first embodiment, the effective CPU can be allocated by setting the device table 2. The allocation of the effective CPU according to the first embodiment is advantageous in that it can be easily implemented in a system.

### Second Embodiment

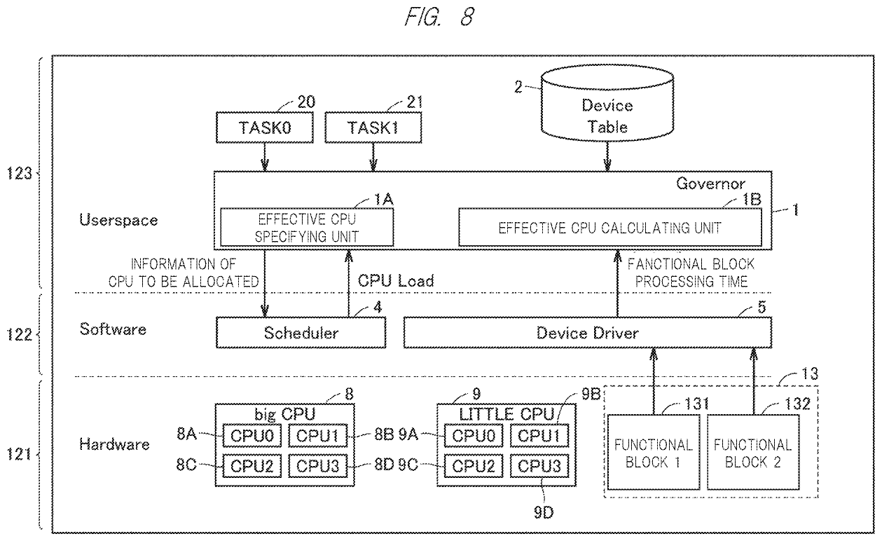

Since a configuration of a semiconductor integrated circuit according to a second embodiment is basically the same as the configuration of the semiconductor integrated circuit 100 shown in FIG. 1, the following description will not be repeated. FIG. 8 is a diagram illustrating a configuration of hardware and software of a semiconductor integrated circuit 100 according to the second embodiment in a hierarchical manner.

Referring to FIG. 8, in the second embodiment, the governor 1 acquires the processing time of the functional block from the device driver 5. In FIG. 8, functional blocks 131 and 132 included in the functional block group 13 are illustrated. The types of the functional blocks 131 and 132 are not particularly limited, and may be, for example, the VCP 113A, the GPU 113B, the USB controller 113C, the SD host controller 113D, the I2C controller 113E, or the like shown in FIG. 1.

The device driver 5 monitors the processing time of the corresponding functional block. The monitored processing time value is sent from the device driver 5 to the governor 1.

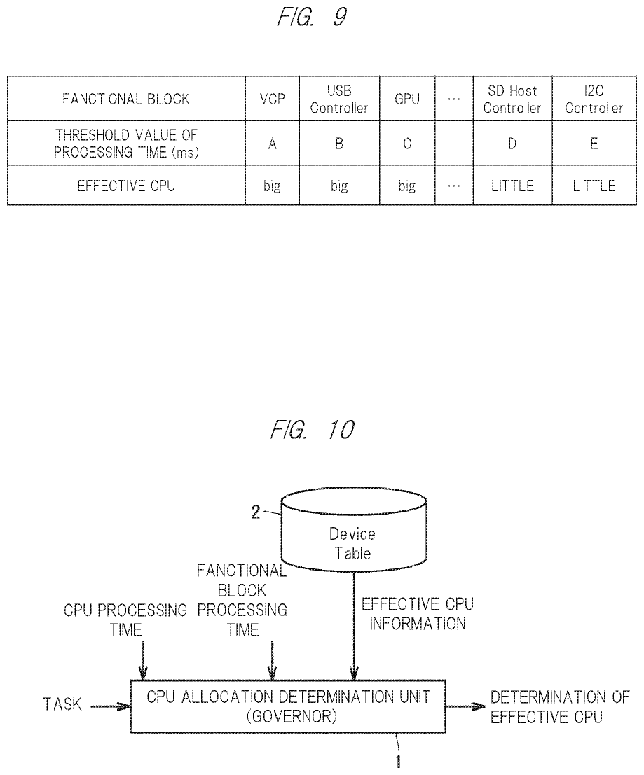

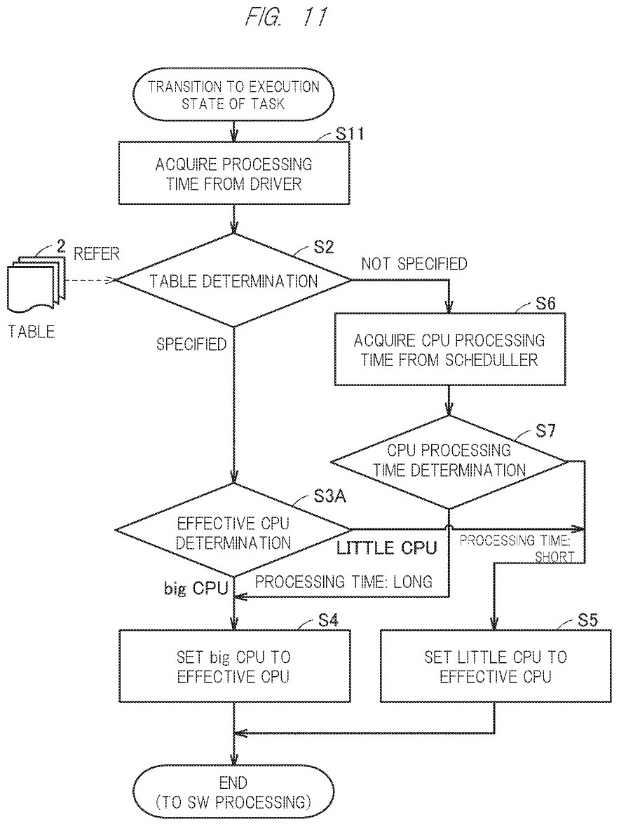

FIG. 9 is a diagram showing a data structure of definition information according to the second embodiment. As shown in FIG. 9, in the second embodiment, the threshold value of the processing time is associated with the functional block in addition to the effective CPU. In FIG. 9, “A”, “B”, “C”, “D”, and “E” represent threshold values of the processing times of the VCP 113A, the GPU 113B, the USB controller 113C, the SD host controller 113D, and the I2C controller 113E, respectively. For example, a threshold value can be set for each functional block by profiling the utilization rate of the use case in advance. The threshold values of the processing time allocated to the functional blocks associated with the LITTLE CPU are required for configuring the device table 2, and are not essential for allocating the effective CPU.

FIG. 10 is a schematic diagram for explaining an outline of a CPU allocation determination unit 1 according to the second embodiment. Referring to FIG. 10, in the second embodiment, the CPU allocation determination unit 1 monitors the processing time of the functional block in addition to the CPU processing time of the task. The governor 1 refers to the device table 2 and determines whether or not a functional block for executing a task is registered in the device table 2. The governor 1 determines a CPU group for operating the task based on the CPU processing time and the processing time of the functional blocks.

As shown in FIG. 8, when a plurality of tasks is simultaneously transitioned to the execution state, the governor 1 determines for each task whether the effective CPU allocated to the task is the big CPU or the LITTLE CPU. A plurality of functional blocks to be controlled by a plurality of tasks is simultaneously in the operation state. Similarly to the first embodiment, the governor 1 checks whether or not each functional block is in the operation state, but does not check the relationship between the functional block in the operation state and the task. When a functional block associated with the big CPU is included in the functional block in the operation state and the processing time of the functional block exceeds the threshold value, the governor 1 allocates the big CPU to the task. Since the times of determining the effective CPUs are substantially the same among the plurality of tasks, the big CPU is allocated to all of the plurality of tasks.

FIG. 11 is a flowchart illustrating an operation flow of the CPU allocation determination unit (governor 1) according to the second embodiment. Processing shown in this flowchart is executed by the big CPU or the LITTLE CPU. Similarly to the flowchart shown in FIG. 7, the flowchart of FIG. 11 shows the allocation processing of the CPU to one task. Therefore, when a plurality of tasks is simultaneously in the execution state, the processing of the flowchart shown in FIG. 11 is executed in parallel by the number of tasks. Referring to FIG. 11, the task transitions from the executable state to the execution state.

Next, processing of step S11 is executed instead of the processing of step S1 shown in FIG. 7. In step S11, the CPU allocation determination unit (governor 1) acquires the processing time of the functional block in the operation state from the device driver 5.

Next, the processing of step S2 is executed. The governor 1 refers to the device table 2 and determines whether or not the functional block specified in the device table 2 is included in the functional blocks in the operation state. When the functional block specified in the device table 2 is included in the functional blocks in the operation state (step S2: “specified”), the governor 1 executes effective CPU determination processing in step S3A.

If there is a functional block associated with the big CPU among the functional blocks in the operation state, and the processing time of the functional block exceeds the threshold value, the processing proceeds to step S4. In this instance, the effective CPU is set to cause tasks to be executed by the big CPU.

If a functional block associated with the big CPU is included in the functional blocks in the operation state, but the processing time of the functional block is less than the threshold value, or if all the functional blocks in the operation state are associated with the LITTLE CPU, the processing proceeds to step S5. The governor 1 sets the effective CPUs for the tasks to the LITTLE CPU.

Similarly to the first embodiment, when all of the functional blocks registered in the device table 2 are in non-operation state, the processing proceeds to steps S2, S6, and S7 in this order. In step S4 or step S5, the effective CPU for operating the task is determined based on the CPU processing time.

Taking USB as an example, some USB devices, such as a USB mouse, have a relatively small CPU load when a task is operated. On the other hand, some USB devices have a relatively large CPU load, such as a USB memory. According to the first embodiment, since the big CPU is defined in the device table 2 so as to be allocated to the USB device, the big CPU is set to the effective CPUs regardless of the type of the USB device. Therefore, in the first embodiment, even if a task that does not necessarily require a high-performance CPU, such as an operation of the USB mouse, is included in a plurality of tasks, the big CPU is allocated to the task (the operation of the USB mouse) based on the information defined in the device table 2. In the first embodiment, when a plurality of tasks is concurrently in the execution state and the plurality of tasks includes the task of operating the USB mouse, the big CPU is allocated to all of the plurality of tasks.

In the second embodiment, the governor 1 grasps the processing time of the functional block in addition to the CPU processing time. In the device table 2, not only the functional block and the effective CPU are associated with each other, but also the threshold value of the processing time of the functional block is registered. According to the second embodiment, even when a functional block is associated with the big CPU in the device table 2, all the tasks in operation are allocated to the LITTLE CPU if the processing times of the functional block are less than the threshold values.

For example, when a USB memory, an SD card, and an I2C IC are used, a USB controller, an SD host controller, and an I2C controller are used as functional blocks. As shown in FIG. 9, in the device table 2, the USB controller and the big CPU are associated with each other, and the SD host controller and the I2C controller are associated with the LITTLE CPU. When a plurality of tasks realized by the USB controller, the SD host controller, and the I2C controller is simultaneously in the execution state, and the processing time of the USB controller exceeds the threshold value B, the big CPU is allocated to all of the plurality of tasks. Next, a case where a USB mouse, an SD card, and an I2C IC are used will be described. Functional blocks used in this case are the same as those described in the above example. However, when a plurality of tasks realized by the USB controller, the SD host controller, and the I2C controller is simultaneously in the execution states, and the processing time of the USB controller is lower than the threshold value B, the LITTLE CPU is allocated to all of the plurality of tasks. In the second embodiment, even when the same functional block is used, tasks can be allocated to a more appropriate CPU from the viewpoint of processing time and power consumption. Therefore, in a system including a plurality of CPUs having different performances, parallel processing performances can be improved.

### Third Embodiment

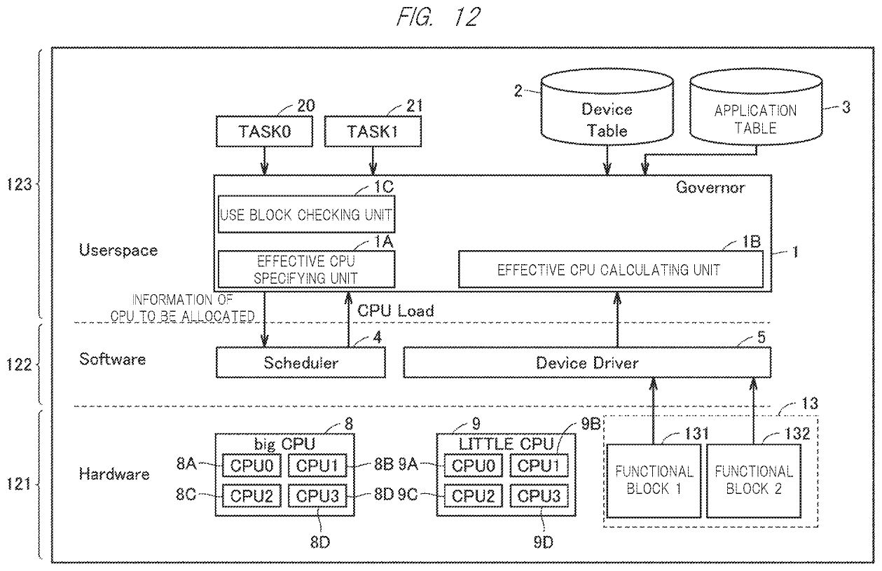

Since a configuration of a semiconductor integrated circuit according to a third embodiment is basically the same as the configuration of the semiconductor integrated circuit 100 shown in FIG. 1, the following description will not be repeated. FIG. 12 is a diagram illustrating a configuration of hardware and software of a semiconductor integrated circuit 100 according to the third embodiment in a hierarchical manner.

Referring to FIG. 12, in the third embodiment, the governor 1 is different from the configuration shown in FIG. 8 in that it further includes a use block checking unit 1C. The use block checking unit IC determines a functional block used by a task that has shifted to the execution state. The use block checking unit 1C may specify an application for executing the task that has shifted to the execution state, and use the application table 3 to specify the functional block to be used from the specified application software. Of the configuration shown in FIG. 12, portions other than the use block checking unit IC is the same as the configuration of the corresponding portion shown in FIG. 8, and therefore, the following description will not be repeated.

The application table 3 is a table in which functional blocks used for executing an application are registered. For example, once an application is executed, the functional blocks used for that application are registered in the application table 3. At the time of the second or subsequent execution of the application, the functional block to be used can be specified from the information registered in the application table 3. However, the means and processes for associating the application with the functional blocks are not limited to the methods described above.

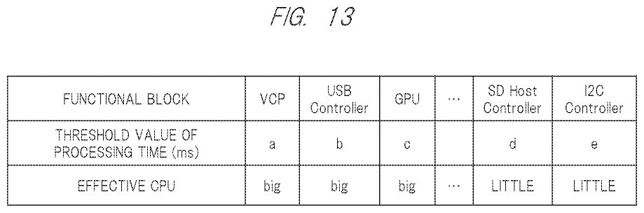

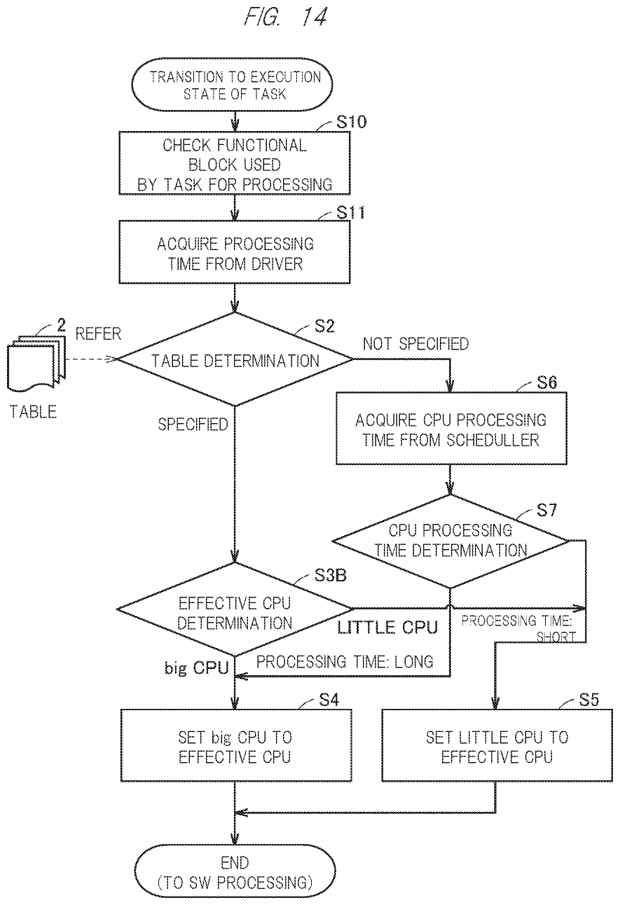

FIG. 13 is a diagram showing a data structure of definition information according to the third embodiment. The data structure shown in FIG. 13 is basically the same as the data structure of the definition information shown in FIG. 9. In order to distinguish from the second embodiment, in FIG. 13, the threshold values of the processing times of the VCP 113A, the GPU 113B, the USB controller 113C, the SD host controller 113D, and the I2C controller 113E are represented as “a”, “b”, “c”, “d”, and “e”, respectively.

FIG. 14 is a flowchart illustrating an operation flow of a CPU allocation determination unit (governor 1) according to the third embodiment. Processing shown in the flowcharts is executed by the big CPU or the LITTLE CPU executing the programs. Similarly to the flowcharts shown in FIGS. 7 and 11, the flowchart in FIG. 14 show the allocation processing of the CPU to one task. Therefore, when a plurality of tasks is simultaneously in the execution state, the processing of the flowchart shown in FIG. 14 is executed in parallel by the number of tasks.

Referring to FIG. 14, when the task shifts from the executable state to the execution state, processing of step 10 is executed. In step S10, the governor 1 (use block checking unit 1C) checks the functional block used by the task for processing. In step S11, the CPU allocation determination unit (governor 1) acquires the processing time of the functional block related to the task from the device driver 5. Next, the processing of step S2 is executed. The governor 1 refers to the device table 2 to determine whether or not the functional block related to the task in the execution state is the functional blocks specified in the device table 2. When the functional block to be determined is specified in the device table 2 (step S2: “specified”), the governor 1 executes effective CPU determination processing in step S3B.

In step S3B, the governor 1 acquires information on the effective CPU and the threshold value associated with the functional block from the device table 2. If the processing time of the functional block associated with the big CPU exceed the threshold value, the governor 1 sets the effective CPU to execute the task in the big CPU in step S4. Therefore, the performance of the system is prevented from deteriorating. On the other hand, if the processing time of the functional block is less than the threshold value even if the effective CPU corresponding to the specified functional block is big CPU, or if the LITTLE CPU is registered as the effective CPU corresponding to the specified functional block, the processing proceeds to step S5. The governor 1 sets the effective CPU for the task to the LITTLE CPU. This makes it possible to reduce the power consumption of the system.

In the third embodiment, the processing time of the functional block is grasped for each task in the execution state, and the task requiring the processing performance is specified. The governor 1 allocates a big CPU to the effective CPU that operates the task. This makes it possible to avoid performance degradation of the system. On the other hand, the task that does not require performance is specified, and a LITTLE CPU is allocated to the effective CPU that operates the task. As a result, power consumption can be reduced. Since a plurality of tasks which is simultaneously executed can be shared by the big CPU and the LITTLE CPU from the viewpoint of the required processing performance, the parallel processing performance can be improved while suppressing an increase in power consumed. Further, in the third embodiment, the governor 1 checks the functional block to be used. As a result, the governor 1 can reliably determine whether or not the functional block is a functional block registered in the device table 2. Thus, the optimum CPU from the big CPU and the LITTLE CPU can be allocated for the operation of the task.

According to each of the above embodiments, the semiconductor integrated circuit 100 includes two CPU groups having different performances. However, the present embodiment is not so limited. The semiconductor integrated circuit 100 may include three or more CPU groups having different performances.

The semiconductor integrated circuit according to each of the above embodiments is not limited to be applied to an in-vehicle system. For example, the semiconductor integrated circuit according to each of the above embodiments can be applied to a server system. While the server system is required to have high performance, it is also required to suppress heat generation. According to each of the above embodiments, it is possible to allocate a high-performance CPU when a task having a low CPU load is operated while processing performance is required. Therefore, the processing performance of the server system can be maintained or improved. On the other hand, according to each of the above embodiments, a low-performance CPU can be allocated when a task that does not necessarily require high processing performance is operated. In this case, heat generation of the server system can be suppressed.

When a plurality of tasks is sequentially executed one by one, the number of functional devices in operation is one. Therefore, it is also possible to specify the functional device in operation in the first embodiment and the second embodiment. In such a case, the processing relating to the allocation of the effective CPU is substantially the same between the second embodiment and the third Embodiment. The allocation of the effective CPU in the first embodiment is different from the allocation of the effective CPU in the second embodiment and the third embodiment in that the processing of comparing the processing time of the functional block associated with the big CPU with the threshold value is omitted.

Although the invention made by the present inventors has been specifically described based on the embodiment, the present invention is not limited to the above embodiment, and needless to say, various changes may be made without departing from the scope thereof.

What is claimed is:

1. A semiconductor integrated circuit comprising:
a plurality of Central Processing Units (CPUs), each of CPUs having a different performance respectively;
a plurality of functional blocks; and
an allocation determination unit that determines an effective CPU allocated to a task realized by at least one of the plurality of functional blocks according to definition information defining a relationship between the plurality of functional blocks and any one of the plurality of CPUs.

2. The semiconductor integrated circuit according to claim 1, wherein the allocation determination unit determines a functional block in an operation state from among the plurality of functional blocks, and determines the effective CPU allocated to the task realized by the functional block in the operating state.

3. The semiconductor integrated circuit according to claim 2, wherein the allocation determination unit acquires a state of supply of power to each of the plurality of functional blocks to determine the operation state.

4. The semiconductor integrated circuit according to claim 3, wherein the allocation determination unit determines that a functional block to which a clock is supplied is the functional block in the operation state.

5. The semiconductor integrated circuit according to claim 2,
wherein the plurality of functional blocks includes a first functional block associated with a high-performance CPU of the plurality of CPUs according to the definition information, and a second functional block associated with a low-performance CPU of the plurality of CPUs according to the definition information, and
wherein, when the first functional block and the second functional block are in the operation state, the allocation determination unit determines that the high-performance CPU is the effective CPU allocated to a task realized by the first functional block and a task realized by the second functional block.

6. The semiconductor integrated circuit according to claim 5, wherein, when the first functional block is in a non-operation state and the second functional block is in the operating state, the allocation determination unit determines that the low-performance CPU is the effective CPU allocated to the task realized by the second functional block.

7. The semiconductor integrated circuit according to claim 1, wherein, when any of the plurality of functional blocks is in a non-operation state, the allocation determination unit determines the effective CPU according to information on a CPU load for operating the task.

8. The semiconductor integrated circuit according to claim 7, wherein the allocation determination unit:
determines that a high-performance CPU among the plurality of CPUs is the effective CPU when the CPU load is large, and
determines that a low-performance CPU among the plurality of CPUs is the effective CPU when the CPU load is small.

9. The semiconductor integrated circuit according to claim 7, wherein the allocation determination unit determines that a high-performance CPU among the plurality of CPUs is the effective CPU when the information on the CPU load cannot be acquired.

10. The semiconductor integrated circuit according to claim 1,
wherein the definition information further includes a threshold value of a processing time of each of the plurality of functional blocks,
wherein the allocation determination unit acquires information on the processing time of the functional blocks,
wherein the plurality of functional blocks includes at least one first functional block associated with a high-performance CPU of the plurality of CPUs according to the definition information, and
wherein the allocation determination unit determines that the high-performance CPU is the effective CPU allocated to a task realized by the at least one first functional block when the processing time of the at least one first functional block exceeds the threshold value.

11. The semiconductor integrated circuit according to claim 10,
wherein the plurality of functional blocks further includes at least one second functional block associated with a low-performance CPU of the plurality of CPUs according to the definition information, and
wherein, when the at least one first functional block is in a non-operation state and the at least one second functional block is in an operation state, the allocation determination unit determines that the low-performance CPU is the effective CPU allocated to a task realized by the at least one second functional block.

12. The semiconductor integrated circuit according to claim 1, wherein the allocation determination unit determines a functional block used for a task that has transitioned to an execution state among the plurality of functional blocks, and determines whether or not the used functional block is defined in the definition information.

13. The semiconductor integrated circuit according to claim 12,
wherein the definition information further includes a threshold value of a processing time of each of the plurality of functional blocks,
wherein the allocation determination unit acquires information on the processing time of the functional blocks,
wherein the plurality of functional blocks includes at least one first functional block associated with a high-performance CPU of the plurality of CPUs according to the definition information, and
wherein the allocation determination unit determines that the high-performance CPU is the effective CPU allocated to a task realized by the at least one first functional block when the processing time of the at least one first functional block exceeds the threshold value.

14. The semiconductor integrated circuit according to claim 13,
wherein the plurality of functional blocks further includes at least one second functional block associated with a low-performance CPU of the plurality of CPUs according to the definition information, and
wherein, when the at least one first functional block is in a non-operation state and the at least one second functional block is in an operation state, the allocation determination unit determines that the low-performance CPU is the effective CPU allocated to a task realized by the at least one second functional block.

15. A Central Processing Unit (CPU) allocation method in a semiconductor integrated circuit that includes a plurality of CPUs and a plurality of functional blocks, each of CPUs having a different performance respectively, the method comprising:
referring to definition information defining a relationship between the plurality of functional blocks and any of the plurality of CPUs; and
determining an effective CPU allocated to a task realized by at least one of the plurality of functional blocks according to the referred definition information.

16. The CPU allocation method according to claim 15, further comprising determining the effective CPU according to information on a CPU load for operating the task when any of the plurality of functional blocks is in a non-operation state.

17. The CPU allocation method according to claim 15,
wherein the plurality of functional blocks includes a first functional block associated with a high-performance CPU of the plurality of CPUs according to the definition information, and a second functional block associated with a low-performance CPU of the plurality of CPUs according to the definition information, and
wherein the determining the effective CPU comprises determining that the high-performance CPU is the effective CPU allocated to a task realized by the first functional block and a task realized by the second functional block.

18. A program executed by a semiconductor integrated circuit including a plurality of Central Processing Units (CPUs) and a plurality of functional blocks, each of CPUs having a different performance respectively, the program allowing at least one of the plurality of CPUs to execute the procedures of:
referring to definition information defining a relationship between the plurality of functional blocks and any of the plurality of CPUs; and
determining an effective CPU allocated to a task realized by at least one of the plurality of functional blocks according to the referred definition information.
